(19) United States
(12) Patent Application Publication
(10) Pub. No.: US 2026/0351473 A1
(43) Pub. Date: Nov. 5, 2026

(54) INSULATION DESIGN OF A LOOSELY COUPLED HIGH ISOLATION MEDIUM FREQUENCY TRANSFORMER FOR MEDIUM VOLTAGE POWER CONVERTERS

(71) Applicant: North Carolina State University, Raleigh, NC (US)

(72) Inventors: Srdjan Miodrag Lukic, Raleigh, NC (US); Fei Teng, Raleigh, NC (US); Wensong Yu, Raleigh, NC (US); Erik Bishop, Raleigh, NC (US); Zeljko Pantic, Raleigh, NC (US); Andrew Galamb, Raleigh, NC (US)

(21) Appl. No.: 19/652,443

(22) Filed: Apr. 20, 2026

Related U.S. Application Data
(60) Provisional application No. 63/791,025, filed on Apr. 18, 2025.

(51) Int. Cl. H01F 27/36; H01F 27/24; H01F 27/28

(52) U.S. Cl. CPC H01F 27/36; H01F 27/24; H01F 27/28

(57) ABSTRACT

Various examples are provided related to high isolation transformers. In one example, a transformer includes a primary side magnetic core; a secondary side magnetic core; an isolation sheet between the primary side magnetic core and the secondary side magnetic core; a primary winding wound about a section of the primary side magnetic core; and a secondary winding wound about a section of the secondary side magnetic core. The isolation sheet includes slots that can receive ends of the primary side magnetic core and the secondary side magnetic core and includes shielding located between the primary side magnetic core and the secondary side magnetic core. The primary and secondary windings are separated by the isolation sheet including the shielding.

### CROSS REFERENCE TO RELATED APPLICATIONS

This application claims priority to, and the benefit of, U.S. provisional application entitled “Insulation Design of a Loosely Coupled High Isolation Medium Frequency Transformer for Medium Voltage Power Converters” having Ser. No. 63/791,025, filed Apr. 18, 2025, which is hereby incorporated by reference in its entirety.

### STATEMENT REGARDING FEDERALLY SPONSORED RESEARCH OR DEVELOPMENT

This invention was made with government support under DE-EE0009871 awarded by the U.S. Department of Energy. The government has certain rights in the invention.

### BACKGROUND

Research in medium voltage (MV) solid-state transformers (SSTs) has significantly increased in recent years for applications such as electric vehicle (EV) fast charging and data centers. Recent EV chargers often have a MV to low voltage (LV) power conversion by direct connection to the MV distribution network. However, this can introduce new challenges to the SST's medium frequency transformer (MFT) design since this component can provide the galvanic isolation barrier between the MV grid and LV user interface. To achieve a high charging power capacity, the SST can adopt cascaded identical submodules, in an input-series output-parallel configuration. However, the cascaded connection can require the MFT to handle a voltage stress higher than 20 kV for a 15 kV class system, considering a safety margin. Partial discharge free operation at the 20kV voltage level can be an issue for MFTs lacking high insulation strength and can hinder long-term transformer reliability.

### SUMMARY

Aspects of the present disclosure are related to high isolation transformers. In one aspect, among others, a transformer comprises a primary side magnetic core comprising ferromagnetic material; a secondary side magnetic core comprising the ferromagnetic material; an isolation sheet disposed between the primary side magnetic core and the secondary side magnetic core, the isolation sheet comprising a plurality of slots configured to receive ends of the primary side magnetic core and the secondary side magnetic core, the isolation sheet comprising shielding located between the primary side magnetic core and the secondary side magnetic core; a primary winding wound about a section of the primary side magnetic core; and a secondary winding wound about a section of the secondary side magnetic core, the primary winding and secondary winding separated by the isolation sheet comprising the shielding. In one or more aspects, the primary winding can be laminated with insulation paper interposed between each layer of turns of the primary winding and the secondary winding can be laminated with insulation paper interposed between each layer of turns of the secondary winding. Each slot can further comprise a potting compound interposed between the isolation sheet and the primary side magnetic core, the secondary side core, or both.

In various aspects, the shielding can comprise a shielding layer disposed within the potting compound. The shielding layer can be positioned in a slot of the isolation sheet with openings to receive the ends of the primary side magnetic core. The shielding layer can comprise semiconductive material with a surface conductivity in a range from about 0.0001 S/m to about 100 S/m. The shielding can comprise conductive or semiconductive particles distributed within the potting compound. The potting compound can comprise epoxy, silicone gel mixed with the conductive or semiconductive particles to make a semiconductive material. The conductive particles can comprise graphite, aluminum, or carbon particles or the semiconductive particles comprise SiC particles. The potting compound can comprise epoxy, silicone gel, or a combination of any thereof. The isolation sheet can have an insulation capability of 20 kV/mm or greater. The isolation sheet can comprise polypropylene. The primary side magnetic core and secondary side magnetic core can be wound ribbon cores. The primary side magnetic core and secondary side magnetic core cab be block cores.

In one or more aspects, the primary side magnetic core and the secondary side magnetic core can comprise silicon steel, nanocrystalline, or amorphous core laminations. The primary side magnetic core and the secondary side magnetic core can comprise ferrite. The secondary side magnetic core can comprise a U-shaped core or an E-shaped core. The primary side magnetic core can comprise a U-shaped core or an E-shaped core. In various aspects, the transformer can comprise a primary auxiliary winding wound about an exterior of the primary side magnetic core; and a secondary auxiliary winding wound about an exterior of the secondary side magnetic core, the primary auxiliary winding and secondary auxiliary winding separated by the isolation sheet comprising the shielding. The transformer can comprise a second secondary side magnetic core on a side of the primary side magnetic core opposite the secondary side magnetic core; a second isolation sheet disposed between the primary side magnetic core and the second secondary side magnetic core, the second isolation sheet comprising a plurality of slots configured to receive ends of the primary side magnetic core and the second secondary side magnetic core; and a second secondary winding wound about a section of the second secondary side magnetic core. The transformer can comprise a primary auxiliary winding wound about an exterior of the primary side magnetic core; a secondary auxiliary winding wound about an exterior of the secondary side magnetic core, the primary auxiliary winding and secondary auxiliary winding separated by the isolation sheet comprising the shielding; and a second secondary auxiliary winding wound about an exterior of the second secondary side magnetic core, the primary auxiliary winding and second secondary auxiliary winding separated by the second isolation sheet comprising shielding. The transformer can comprise a current limiting resistor and a transient voltage suppression diode connected between the primary winding and the shielding and/or a current limiting resistor and a transient voltage suppression diode connected between the secondary winding and the shielding. The transformer can comprise a current limiting resistor connected between the primary side magnetic core and the shielding and/or a current limiting resistor connected between the secondary side magnetic core and the shielding.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration depicting examples of transformer geometry types commonly used in MV MFTs, such as a shell type (left) and a core type (right), in accordance with various embodiments of the present disclosure.

FIG. 2 is an example of E field distribution in a shell type transformer with grounded magnetic cores, in accordance with various embodiments of the present disclosure.

FIG. 3 is an example of E field distribution in a shell type transformer with floating cores, in accordance with various embodiments of the present disclosure.

FIG. 4 is an image depicting an example of a transformer according to one embodiment of the present disclosure, in accordance with various embodiments of the present disclosure.

FIG. 5 is a 2D section view of an example of a transformer according to one embodiment of the present disclosure, in accordance with various embodiments of the present disclosure.

FIG. 6 is an example of E field distribution in a transformer with 30 kV voltage stress applied according to one embodiment of the present disclosure, in accordance with various embodiments of the present disclosure.

FIG. 7 is a graph showing an example of the measurement of transformer impedance over frequency, in accordance with various embodiments of the present disclosure.

FIG. 8 is an image showing an example of a partial discharge test setup, in accordance with various embodiments of the present disclosure.

FIG. 9 shows and example of partial discharge test waveforms and apparent charge value with 30 kV voltage stress, in accordance with various embodiments of the present disclosure.

FIG. 10 shows a plot of an example of a transformer efficiency estimation under different load conditions, in accordance with various embodiments of the present disclosure.

FIG. 11 is a table showing an example of properties of materials used in a transformer, in accordance with various embodiments of the present disclosure.

FIG. 12 is a table showing an example of electrical parameters of a transformer, in accordance with various embodiments of the present disclosure.

FIG. 13 shows a 2D section view of an example of a transformer, in accordance with various embodiments of the present disclosure.

FIG. 14 is an illustration showing an example of a transformer, in accordance with various embodiments of the present disclosure.

FIG. 15 illustrates an example of a topology of an isolated barrier showing the containment of an E-field within the structure, in accordance with various embodiments of the present disclosure.

FIG. 16 are tables showing examples of isolation sheet and potting materials, in accordance with various embodiments of the present disclosure.

FIG. 17 illustrates examples of topologies using E or U cores, in accordance with various embodiments of the present disclosure.

FIG. 18 is a table illustrating an example of transformer design parameters, in accordance with various embodiments of the present disclosure.

FIG. 19 illustrates an example of e-field distribution in a transformer cross-section, in accordance with various embodiments of the present disclosure.

FIG. 20 illustrates examples of e-field management at the edge of a shield, in accordance with various embodiments of the present disclosure.

FIG. 21 illustrates an example of the effect of shield conductivity on losses, in accordance with various embodiments of the present disclosure.

FIG. 22 is an exploded view illustrating an example of a transformer construction, in accordance with various embodiments of the present disclosure.

FIG. 23 illustrates an example of insulation barrier design with ferrites and shield in place and potted, in accordance with various embodiments of the present disclosure.

FIGS. 24A-24C illustrate examples of HV winding termination and power module HV and LV section construction, in accordance with various embodiments of the present disclosure.

FIG. 25 illustrates an example of Partial Discharge test setup and inception voltage results, in accordance with various embodiments of the present disclosure.

FIG. 26 illustrates an example of reference connections in a transformer, in accordance with various embodiments of the present disclosure.

FIG. 27 illustrates an example of a current limiting resistor and transient voltage suppression (TVS) diode, in accordance with various embodiments of the present disclosure.

FIGS. 28A and 28B illustrate examples of current limiting reference connections, in accordance with various embodiments of the present disclosure.

### DETAILED DESCRIPTION

Disclosed herein are various embodiments of high isolation split transformers and methods related to building high isolation split transformers. Reference will now be made in detail to the description of the embodiments as illustrated in the drawings, wherein like reference numbers indicate like parts throughout the several views.

Interest in medium voltage (MV) solid-state transformers (SSTs) has significantly increased recently for applications such as electric vehicle (EV) fast charging, and data centers. A recent improvement to EV chargers has been the MV to low voltage (LV) power conversion by direct connection to the MV distribution network. However, this can introduce new challenges to the SST's medium frequency transformer (MFT) design, since this component provides the galvanic isolation barrier between the MV grid and LV user interface. To achieve a high charging power capacity, the SST can adopt cascaded identical submodules, in an input-series output-parallel configuration. The cascaded connection can require the MFT to handle a voltage stress higher than 20 kV, for a 15 kV class system, considering a safety margin. In recent years, significant research has been conducted on the design of high isolation MFTs for MV applications. However, as the design of MFTs disclosed herein can be for SST fast chargers connecting to 15 kV class systems, existing designs that have insulation voltage lower than 5 kV are omitted from the discussion herein. MFT prototypes with insulation voltage between 5 kV and 20 kV are included in the discussion herein, as the insulation design considerations can be considered by the present disclosure, although they can often be unable to satisfy the insulation requirements. Therefore, discussion of prior research is focused on MFT designs that have insulation voltages higher than 5 kV.

Prior research has presented an MFT design using oil as the main insulation material for 15 kV railway grid applications. The MFT adopts nanocrystalline C-cut cores and passes a 34.5 kV RMS dielectric test and a 75 kV Basic Insulation Level (BIL) test. A core-type transformer using nanocrystalline cores for 25 kV applications has also been previously introduced. The transformer mainly relies on transformer oil to provide insulation between windings and the core. Yet, no insulation test is presented for this transformer. Other research has illustrated a dry-type transformer that uses the coating of MV cables as the main insulation material, which features a partial discharge extinction voltage (PDEV) of 28 kV with apparent charge less than 10 pC. However, the transformer is designed for 10 kHz low-frequency IGBT-based converters and may not be able to handle higher switching frequencies due to skin effect in the windings. Meanwhile, the coupling capacitance between the primary and secondary windings is around 3 nF, which is relatively high for medium-frequency converters.

Another dry-type MFT that adopts a shell-type structure has been introduced in prior research, which is for 15 kV applications. The core of the MFT is grounded and a 30 mm clearance distance in air between the windings and core is generated to achieve high insulation. The design is experimentally tested with partial discharge (PD) to validate that air can provide sufficient insulation strength by controlling the clearance distance. Another prior study presents a 300 kW MFT filled in oil for 20 kV applications, but the insulation strength is only tested at the 5 kV level. In prior literature, a shell-type transformer using nanocrystalline U cores has also been introduced. It claims that the MFT features no PD at 30 kV thanks to the superior insulation strength of ester oil that covers the whole transformer. However, this study appears to put more efforts on reducing the E-field strength at the transformer terminals.

One previous study presented a shell-type transformer immersed in mineral oil for HVDC applications. The study showed an insulation test that applies up to 125 kV DC stress to the transformer, and it handles the voltage for 4000 seconds without breakdown. Another study introduced an MFT design for power converters to connect to 4160 V distribution system. This study targets for lower voltage level, but the insulation design using epoxy resin to encapsulate transformer windings can be very useful for higher voltage level as well. The transformer passes the 30 kV BIL test, 12 kV hipot test for 60 seconds, and features 3.8 pC apparent charge with 5.4 kV voltage stress in the PD test. Another prior study presented a shell type 100 kW 10 kHz MFT and features 4 kV insulation voltage using 10 pC as the critical apparent charge value to determine the partial discharge inception voltage (PDIV).

In one prior study, an air-core-based MFT was introduced for 166 kW/7 kV applications with a nominal insulation voltage of 10 kV. The air core based MFT has a relatively low coupling coefficient of 0.76 which requires a resonant DC/DC converter stage for efficient operation. Additionally, the MFT has a coupling capacitance of 102 pF which is relatively low considering its volume. Another prior study presented a transformer that uses epoxy and conductive shielding layer to mitigate the electric field (E field) to increase the insulation strength. The proposed MFT features a PDIV of 15 kV (5 pC). The study also conducted an overvoltage test and BIL test on the prototype, which passed 42 kV, and 75 kV voltage stress test, respectively.

According to various embodiments of the present disclosure, disclosed is a core type transformer structure using silicone potting compound and polypropylene (PP) plastic to achieve high voltage insulation.

### CONSIDERATIONS ON MV MFT INSULATION DESIGN

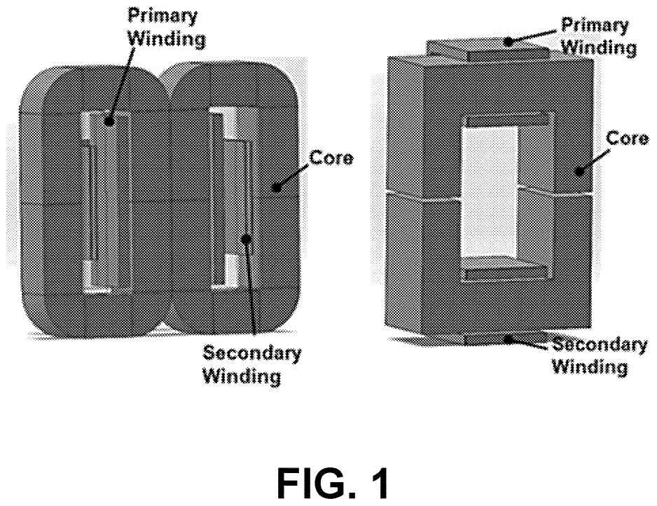

For MFTs with high insulation strength for MV power converters, key design aspects related to insulation performance can be sorted into transformer geometry, main insulation material, and insulation testing methods. From the transformer geometry point of view, recent studies have featured shell type, and core type designs as shown in FIG. 1. Shell type and core type transformers typically use cut cores, such as UU, EE, or EI cores. The primary and secondary windings of a shell type transformer share the same limb or yoke of the magnetic core with insulation materials in between. The leakage inductance is relatively small as the windings overlap, yet voltage stress or high E-field intensity is distributed not only between the windings but also between the inner winding and core. However, core type transformers have primary and secondary windings occupying different yokes or limbs without overlapping. In fact, in core type transformers, windings are separated by the cut cores, and insulation design is relatively easier, with a compromise of higher leakage inductance.

Regarding the main insulation material, air is commonly used in MV MFT designs. Air can be acquired with no cost, and it can reduce the weight of the MFT. More importantly, using air as an insulator has no concerns on aging effects, which is good for long term operations. However, air has relatively low dielectric strength of typically less than 3 kV/mm. Therefore, it usually relies on large clearance distance to reduce the E field strength in the air region to be lower than 3 kV/mm, which makes it difficult to achieve 20 kV insulation with a compact design. Transformer oil and potting compounds are also widely used to enhance the insulation strength of the transformer. Oil filled transformers are rarely seen in recent five years of research, despite oil having superior insulation strength. First of all, transformer oil has relatively low thermal conductivity, typically lower than 0.12 W/mK, and this property has an inverse relationship with temperature. Low thermal conductivity brings difficulties in thermal design of the transformer. Secondly, encapsulating oil not only requires the transformer enclosure to have an enhanced leakproof property which brings extra cost, but also maintenance is not easy to perform on the transformer. Lastly, if any transformer oil leaks, there is potential it catches fire in the electrical environment. And the resulting air bubbles in the oil can lead to PD issues. Potting compounds such as epoxy and silicone gel generally have high dielectric strength higher than 20 kV/mm, thus are good options for compacted designs. By adopting degassing procedures, it is easy to remove air bubbles in the potting compound and avoid PD occurs inside it. Therefore, potting compounds are the preferred insulation materials for using in MV MFTs.

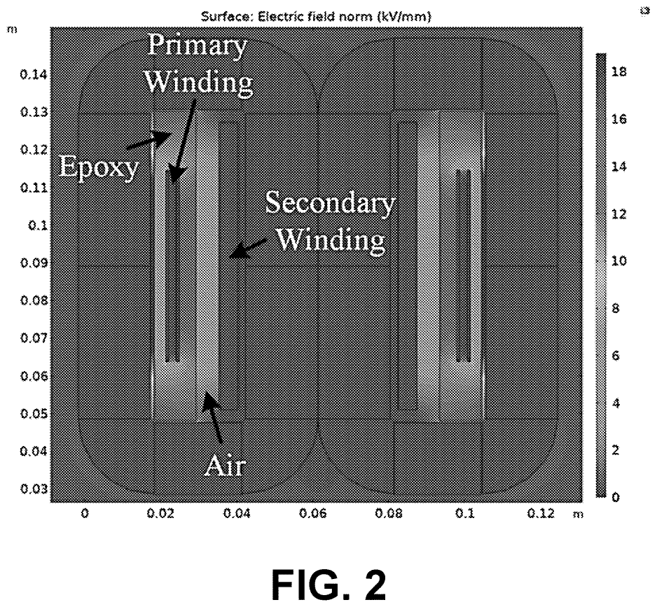

As for insulation testing methods, PD test can indicate the lowest level of safety voltage for long-term operations. The insulation design should focus on ensuring that the transformer can operate above 20 kV with acceptable PD levels. Since the transformer provides the insulation barrier, it is important to identify the locations where a high intensity of the E field exists. For the design of insulation considerations, the following interfaces can be important: primary winding to secondary winding, windings to magnetic cores, and primary core to secondary core. Note that the existence of these interfaces may not be applicable according to transformer geometry. For example, a primary core to secondary core interface exists if the transformer utilizes cut cores. Air-core transformers only have winding to winding interfaces, which is the sole physical barrier for insulation. To clearly visualize the distribution of the E field across the insulation interfaces, simulations are conducted using COMSOL Multiphysics. FIG. 2 demonstrates that E field concentrates between the windings and cores where avoiding air is challenging for shell type transformers. In this case, the primary winding is connected to 30 kV, and the cores and secondary windings are both connected to ground. High E field intensity can be seen in the gap between primary winding and the cores where epoxy and air exist. The E field intensity in different materials is determined by the dielectric constants, and can be estimated by

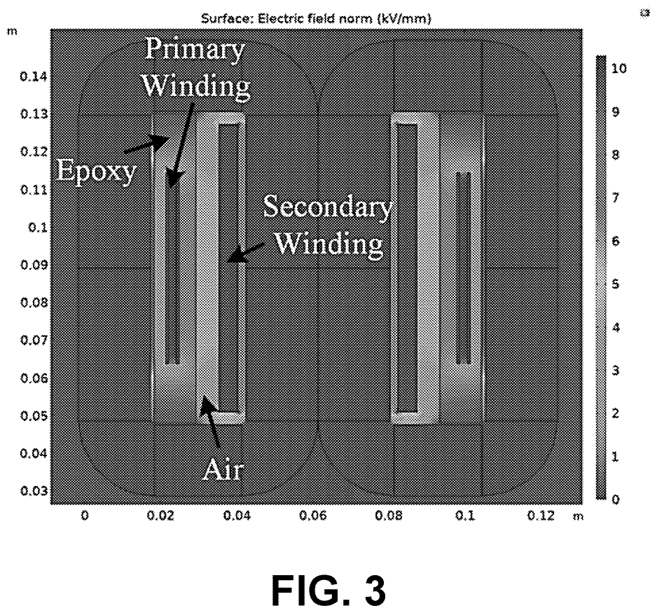

ϵₐᵢᵣEₐᵢᵣ=ϵ_{epoxy}E_{epoxy} (Eq. 1)

where ϵₐᵢᵣ and ϵ_{epoxy} are the dielectric constants, and Eₐᵢᵣ and E_{epoxy} are the E field intensities. As ϵ_{epoxy} is typically 3 to 5 times higher than ϵₐᵢᵣ, E field concentrates more in air. Once the electric field intensity in the air exceeds the inception voltage, PD will start, and the electron streams generated in this process will chemically react with the insulation material, thus deteriorating the material over time. Mitigating the concentration of the E field in this region can be achieved by potting the entire windings or adding shielding layers for the windings. However, these will increase cost and manufacturing difficulty, as well as eddy current losses. FIG. 3 shows the case when the magnetic cores are floating. The potential of the core is free to be raised by the high voltage on the primary windings due to the parasitic coupling, which results in high E field intensity in the interface between primary winding and cores as well. Therefore, it can be challenging to mitigate E field in the critical interfaces for shell type transformers.

Managing the E field intensity in the critical interfaces is easier for core type transformers. By introducing an air gap between the primary and secondary side cores, a distinct MV region and LV region can be created. Considering the core-to-core interface, the high E field is constrained inside the air gap region where potting compounds can be used to eliminate air. The E field intensity in the winding-to-winding interface can be mitigated by inserting insulation materials to separate the windings such that the voltage stress has a larger distance to drop. It is not necessary to encapsulate or shield the windings in this case. As for the winding to core interface, by properly connecting the primary and secondary side cores to MV and LV potentials, the common mode voltage stress will not exist in this interface. One practical solution can be that the primary side cores are connected to the DC bus midpoint at MV side, and the secondary side cores are grounded together with the secondary windings. Therefore, the core type geometry with potting compounds at high E field regions can be adopted in the embodiments disclosed herein.

### TRANSFORMER PROTOTYPING

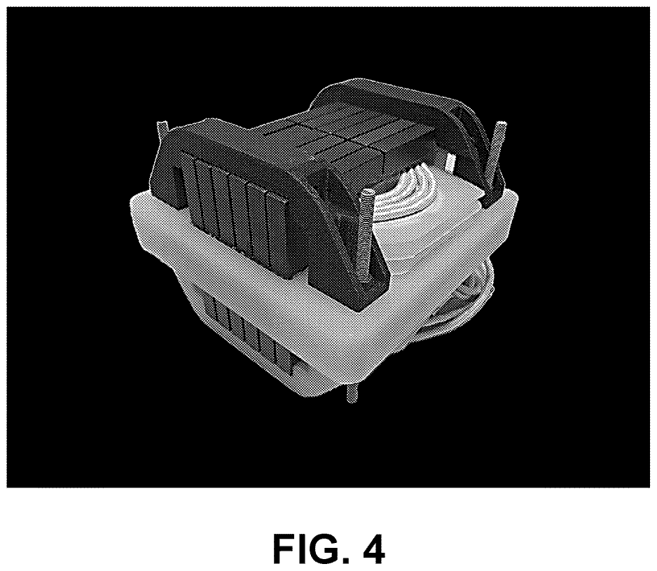

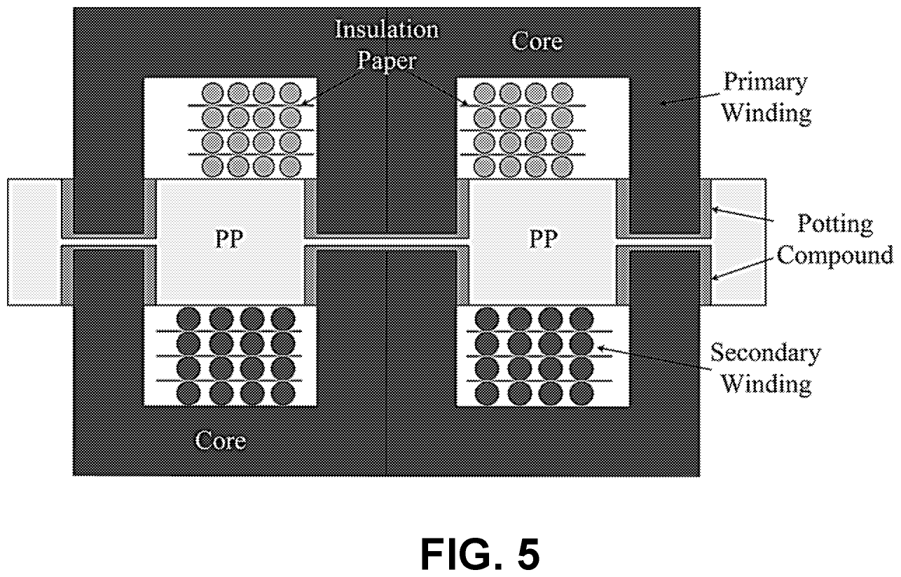

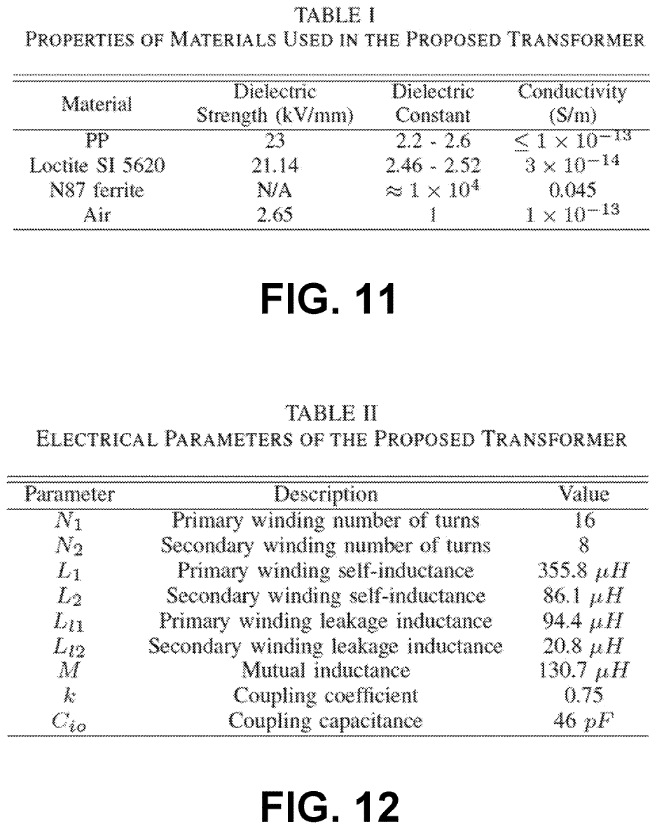

Applying the insulation design considerations discussed in the previous section, a prototype transformer has been constructed and tested to validate the methods. An embodiment of the proposed transformer and its 2D sectional view are shown in FIG. 4 and FIG. 5, respectively. The transformer utilizes a 2-inch thick PP isolation sheet as the insulation barrier between the primary and secondary sides. The PP material is chosen for its excellent temperature rating, high insulation strength of around 23 kV/mm. A thickness of 2 inches effectively separates the windings to prevent corona discharge and provides adequate creepage distance. The PP sheet is machined to create slots for the cores with 7 mm gap distance, and these slots are encapsulated with silicone gel Loctite SI 5620 which has a breakdown voltage of 21 kV/mm. To prevent PD issues caused by the formation of air bubbles inside the silicone gel, the compound was cured under 40 psi pressure at room temperature for 24 hours. U126/91/20 N87 Mn—Zn ferrite cores from TDK are selected, and are assembled using plastic clamps to avoid applying mechanical force to the potting compound, and to form cooling channels between the cores. The N87 ferrite core is measured to have an electrical conductivity of 0.045 S/m which can be considered as a conductive material compared to other insulators. A copper grounding bar on each side electrically shorts the cores together, such that the cores can be connected to high voltage or ground. The windings are made by 3425/0.1 mm litz wire which has an operation frequency of 50 to 100 kHz. A number of turns 16 is on the primary and 8 turns of two wires in parallel on the secondary. Material properties that are related to transformer insulation performance are summarized in Table 1 of FIG. 11.

### SIMULATION AND EXPERIMENTAL RESULTS

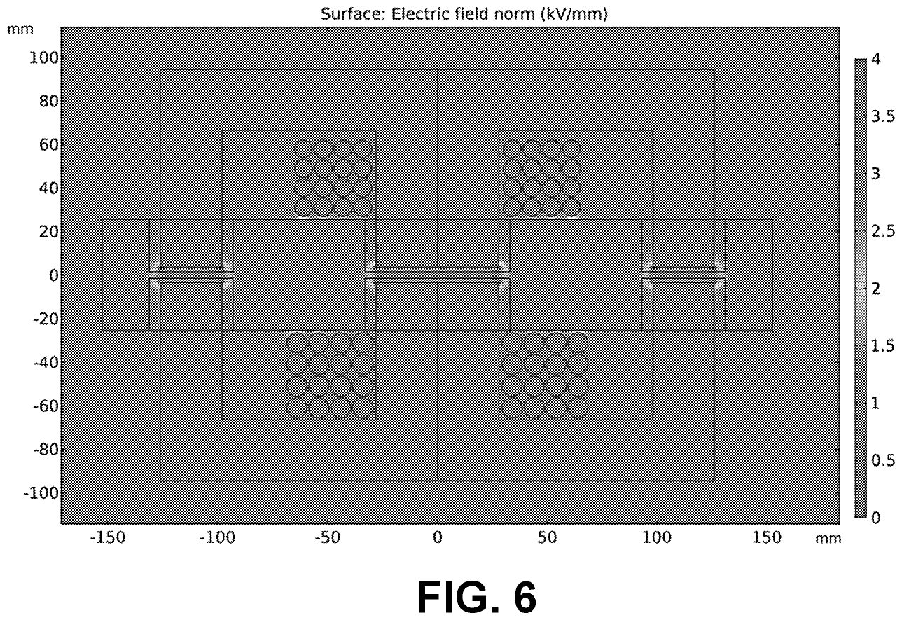

It can be seen from FIG. 6 that by separating the primary and secondary with air gaps and connecting the cores to adequate potential levels as discussed previously, the E field can be concentrated at the air gap region where insulation can be controlled by the silicone gel and PP plastic. The E field intensity in the regions contain air is less than 2 kV/mm according to the simulation, which prevent PD occurs.

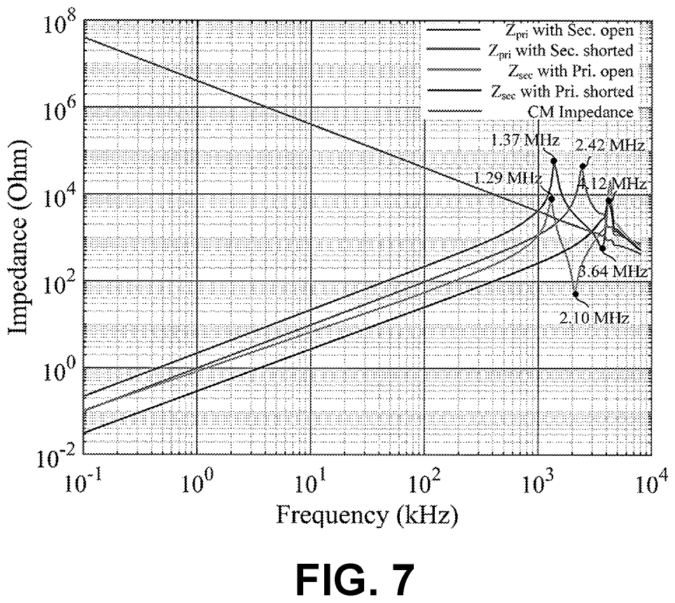

The electrical parameters of the proposed transformer are measured using a HIOKI LCR meter IM3536 and are summarized in Table 2 of FIG. 12. The measurements are performed at 75 kHz, which is the operational frequency for which the MFT is designed. The proposed transformer features a coupling capacitance of 46 pF, which is low for common mode (CM) current generation. The proposed MFT has a relatively low coupling coefficient of 0.75 due to the gap introduced between the cores and the large distance between the windings to achieve high insulation. Therefore, resonant capacitor banks are needed to operate the transformer efficiently. FIG. 7 presents the frequency sweep measurements of selected impedances of the proposed MFT. Winding impedances of the primary and secondary, with the other winding connected in open circuit and shorted, are measured to demonstrate resonant frequencies. Additionally, the CM impedance of the MFT, which is tested by measuring the impedance from the shorted primary winding and shorted secondary winding, is also shown in FIG. 7.

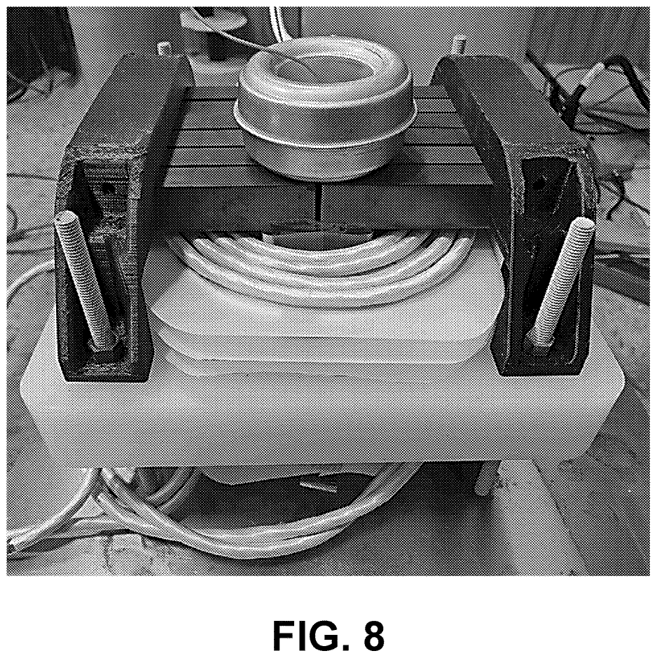

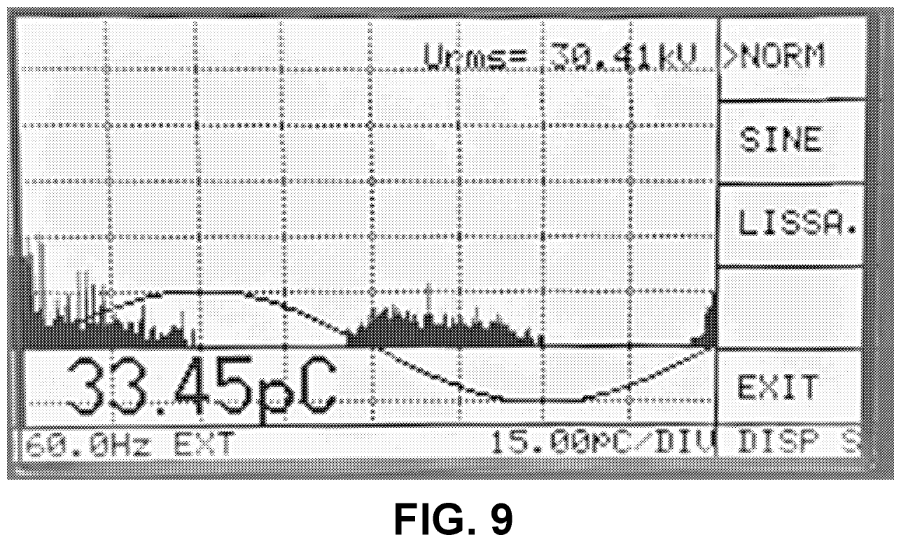

The insulation performance is evaluated using the Phenix Technology Phase Resolved Partial Discharge (PRPD) testing platform. The PD test setup is shown in FIG. 8. During the PD test, the primary winding and ferrite cores on the primary side are connected to the high voltage terminal of the tester. The secondary winding and cores on the secondary side are connected to earth ground. A metal potential equalizer with a round, smooth surface is used to shield the terminal of the PD tester cable to avoid occurrence of corona discharge during PD testing. The background PD noise of the testing equipment was lower than 0.3 pC, and a 10 pC pulse source was used for calibration before testing the MFT prototype. FIG. 9 displays the PRPD waveform at an applied voltage of 30 kV RMS, featuring an apparent charge of 33.5 pC. The measured PDIV of the proposed transformer is 35.5 kV RMS, at which level the apparent charge exceeds 50 pC.

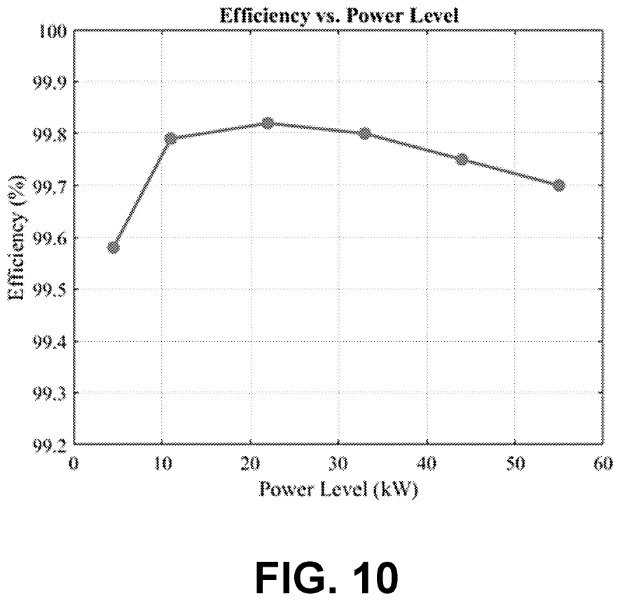

The simulated efficiency of the proposed MFT operated at 75 kHz under different load conditions is shown in FIG. 10, demonstrating a peak efficiency of 99.8%. High voltage, high power resonant capacitor banks can be used to experimentally evaluate the transformer's efficiency.

The present disclosure presents various embodiments of an MFT design with high voltage insulation for MV power converters. Design considerations to achieve high insulation strength without PD are discussed. By introducing a gap between the cores and using a PP isolation sheet as an insulation barrier, the disclosed MFT structure features distinct MV and LV regions and can eliminate the necessity to encapsulate the windings. Simulations demonstrate that the high electric field intensity regions are confined to insulation materials with high dielectric strength. Embodiments of the disclosed transformer exhibit an apparent charge of 33.5 pC under 30 kV RMS voltage stress and a coupling capacitance of 46 pF, validating their effectiveness for use in 15 kV class SSTs. The transformer's peak efficiency is estimated to be 99.8% based on simulations.

### Example

Referring now to FIG. 13, shown is a transformer according to one embodiment of the present disclosure. In some examples, the transformer can be built using ferrite I-shaped cores. The transformer shown can allow for greater flexibility in design and an increased area of gap. The sandwich construction can minimize footprint while maximize a coupling coefficient. In some examples, the coupling coefficient can increase from approximately 0.77 to 0.94.

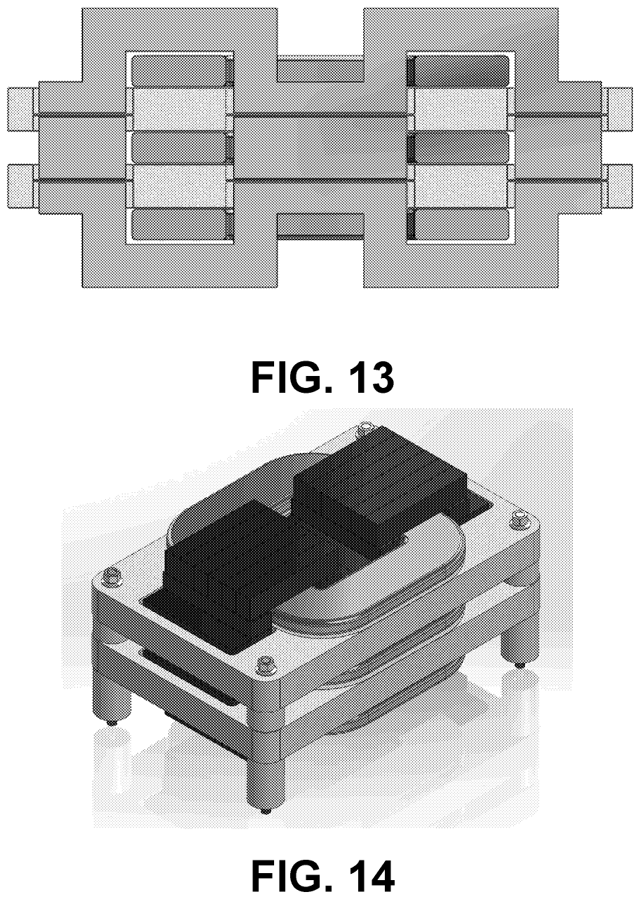

Referring now to FIG. 14, shown is a prototype of the transformer of FIG. 13.

### HEATING EFFECTS

There are many ways to handle the E-field between the high and low voltage winding. In all cases there is a material with high breakdown voltage placed between components referenced to a high potential (typically the HV coil) components referenced to the LV potential (typically the magnetic core and the LV winding). The E-field is then dropped or dissipated across the high breakdown material. While many arrangements of the coils and the cores are possible, two approaches in particular have gained popularity. One encloses the HV winding in the high breakdown material and references the remaining components to the LV side.

A key challenge with enclosing the high voltage (HV) winding in epoxy is the limited capability to dissipate heat from the HV winding. The heat from the copper wire permeates into the semiconductor layer as well as the insulation layers beyond it. As a result, the insulation layer experiences some thermal stress which can degrade the insulation over time. Furthermore, the insulation material limits the maximum current density allowable in the copper conductor since the heat generated by the conductor must pass through the insulation to exit the system. As a result, this approach is effective for systems with lower isolation requirements but becomes less effective when very high voltages are required. due to the exponential increase in the required insulation material between the high voltage and the low voltage winding.

In this work, the planar wireless power transfer (WPT) type approach is adopted to design a high isolation transformer. In this work, a planar isolated gap that precisely controls the E-field between the HV and the LV side. The approach guarantees that the E-field predicted in simulations is achieved in practice.

### Transformer Isolation Structure

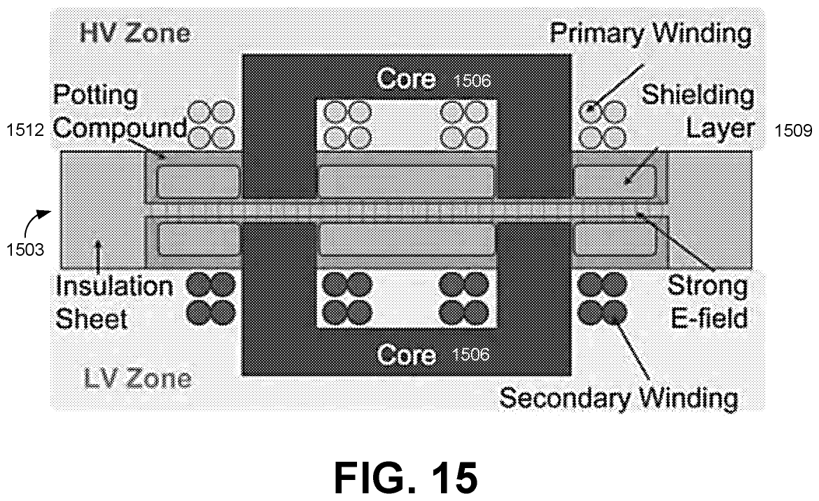

In the proposed design, the E-field is precisely and directly contained within the proposed insulation structure. FIG. 15 illustrates the concept with a simple U-core design having two voltage zones. The design establishes distinct voltage zones by creating a gap that effectively separates the primary and secondary windings. The electric field between the two voltage zones is fully contained within the isolation gap, allowing the distinct voltage zones to be designed as a traditional transformer.

The isolation barrier backbone is an isolation sheet (or insulation sheet) 1503 with machined slots to accept the magnetic cores 1506 and shielding layers 1509. The magnetic cores 1506 and shielding layers 1509 are secured in place with potting compound 1512, such as epoxy or silicone gel. This approach ensures that the path where the E-field is high, the isolation completely void-free and that the path is not exposed to high temperatures or components that shrink and expand, which can cause cracking.

### Selection of Isolation Materials

As shown in FIG. 15, the proposed transformer insulation structure utilizes an isolation sheet 1503, a potting compound 1512, and a shielding layer 1509 to effectively manage the electric field formed between the two voltage zones. Each material should be selected carefully to arrive at an acceptable design.

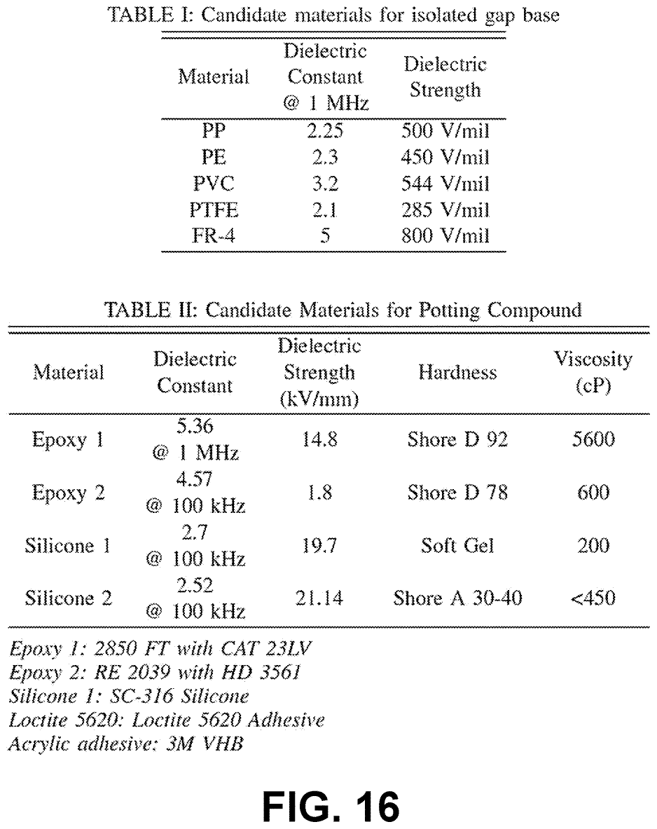

The isolation sheet 1503 can be made from a material that is easy to machine, has high breakdown voltage, has a low relative permeability, has a UL 94 V-0 flammability rating; and a Category I Comparative Tracking Index (CTI) rating. Some candidates for the design are shown in Table I of FIG. 16, all of with can have variants that meet the UL94 V-0 and IEC 60112 Category I CTI ratings.

The potting material 1512 should ensure there are no voids in the path where the E-field is high. Table II of FIG. 16 shows some of the candidate materials. Selection criteria can include: low permeability to ensure that the electric field is primarily dissipated in the isolation sheet 1503 rather than the potting material 1512; relatively low viscosity to facilitate proper flow of the potting material 1512, ensuring complete void fill; reasonably long working time (e.g., 15 minutes); and strong adhesion to the isolation sheet 1503, shielding layer, and ferrite to prevent voids at the material interfaces.

Another important parameter is the relative permeability of the isolation sheet 1503 compared to that of the potting material 1512. The E-field will be strongest in the material with the lower relative permeability. Therefore, the potting material 1512 should have the same or lower relative permeability than the isolation material.

While many materials can be selected to meet these requirements, polypropylene isolation base has been selected for it's good dielectric properties, low permeability, and easy machining; and Epoxy 1 (2850 FT with CAT 23LV) due to its good adhesion properties, relatively low cost and high relative permeability compared to the PP base.

### Shielding Layer Considerations

Shielding layer material selection can be particularly challenging. The material needs a high enough conductivity to provide shielding effect while having a low enough conductivity to minimize the induced currents and therefore the losses in the material. Detailed design and discussion of a shielding layer is presented below.

### Design Considerations

### Transformer Topology

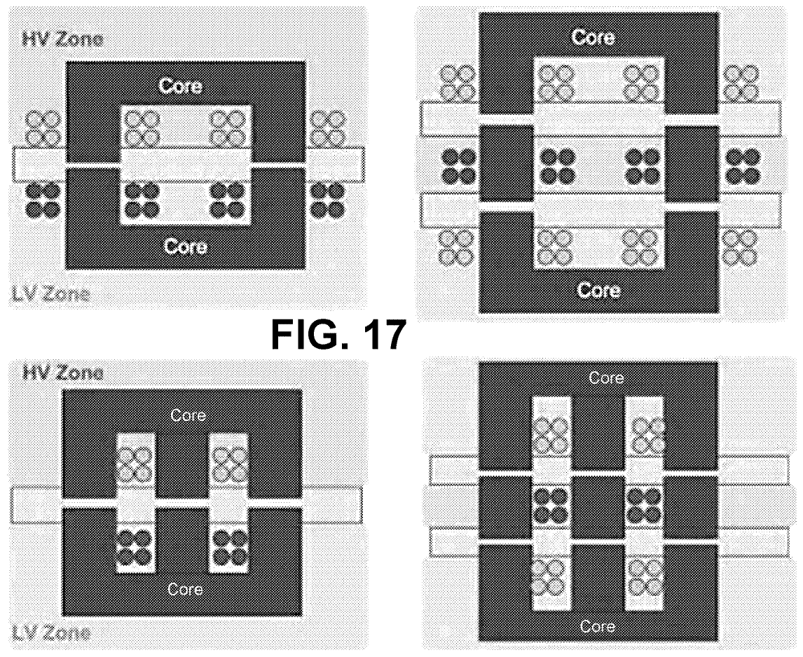

The proposed transformer design considers the basic E and U core topologies, which are well-established in the literature. FIG. 17 illustrates a comparison of topologies using E or U cores. In the top left, a single isolation layer U core design is illustrated, in the top right, a double isolation layer U core design is illustrated, in the bottom left, a single isolation layer E core design is illustrated, and in the bottom right, a double isolation layer E core design is illustrated. As shown in FIG. 17, the U-shaped core offers the advantage of positioning the cores further from the isolation barrier's edge. Given that ferrite cores typically lack isolation or have only a thin layer, it is beneficial to place the core near the middle of the isolation barrier to maximize clearance and creepage distances. Conversely, the windings must possess basic insulation to withstand turn-to-turn or layer-to-layer potential differences within them. Consequently, positioning the windings closer to the isolation barrier's edge is acceptable without compromising the overall creepage and clearance distances.

Comparing the single and two isolation layer designs reveals that in the latter, all exposed ferrites and windings operate at low voltage. This contrasts with the single-layer design, where the high-voltage section is partially exposed. While grounding all exposed cores is not strictly required, this configuration offers an extra safety margin and aligns better with conventional transformer design principles. Based on these considerations, the dual isolation layer design was selected for implementation.

### Magnetic Design in context of isolation constraints

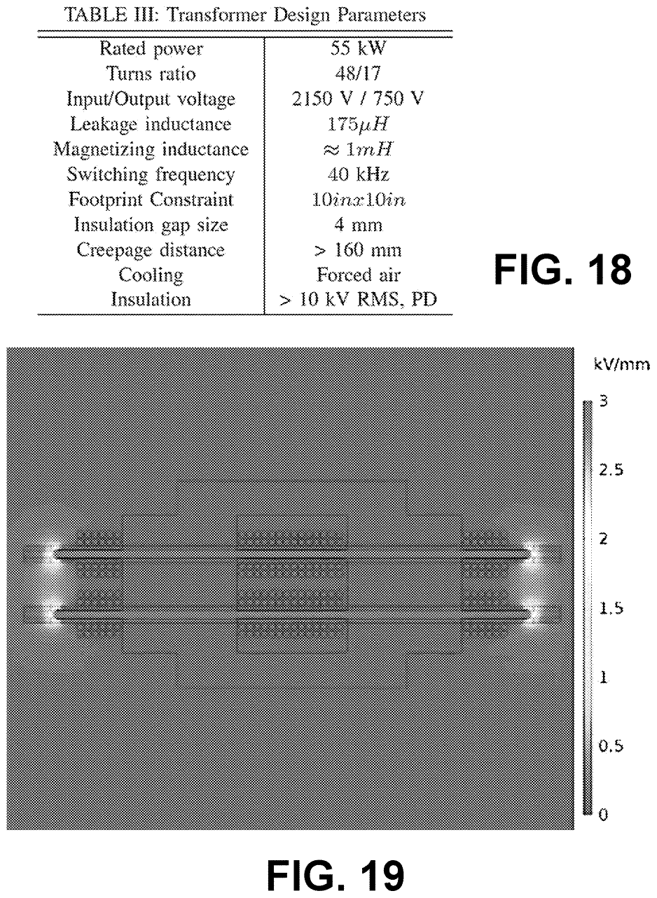

The proposed transformer was to be used as a part of a dual active bridge dc/dc converter used as a part of an SST based electric vehicle fast charger. As a result, circuit parameters were determined prior to the transformer design such as the operating frequency, the input and output voltage ratio, and the target magnetizing and leakage inductance values. These parameters are summarized in Table III of FIG. 18.

The resulting transformer design is shown in FIG. 19, which illustrates the e-field distribution in the transformer cross-section. The design shows the magnetic parameters in Table III of FIG. 18, which satisfy the requirements of the design. The B field in the 2-D cross sectional design is below the target and the highest B field is seen in the top bars due to the relatively small cross-sectional area of the top bar for the flux flow. This implies that the bulk of the core losses and the heating will occur in these. Top bars are easy to cool as they're not enclosed in any way unlike the bars in the middle portion.

### E-field Mitigation

For effective E-field mitigation, some distance is required between the shielding layers, as illustrated in FIG. 19. Based on the selection of polypropylene (PP) as the isolation barrier (the insulation sheet 1503 in FIG. 15), which has an approximate isolation capability of 20 kV/mm, a 4 mm distance between the shielding layers was chosen for the design to be partial discharge (PD) free up to 15 kV. This limited the peak electric field within the PP to below 4 kV/mm (see FIG. 19), providing a significant safety margin. This margin is necessary to account for any imperfections at the interface between the epoxy and the PP, which could potentially lead to partial discharge issues. It also helps ensure that any imperfections or non-uniformness within the material itself does not cause partial discharge issues. FIG. 19 illustrates that the E-field is uniformly distributed along the isolation layer and is well contained between the shields when 15 kV is applied between the low-voltage (LV) and high-voltage (HV) terminals. In this simulation, the shield's conductivity is assumed to be very high, forming a very effective shield; the optimization of the shield's conductivity will be considered in the next section. The highest E-field in the air gap is 1.5 kV/mm, which is well below the 2 kV/mm threshold that could cause partial discharge in air. FIG. 19 also shows that the field dissipates at the edge of the shield, needing careful termination of the shield.

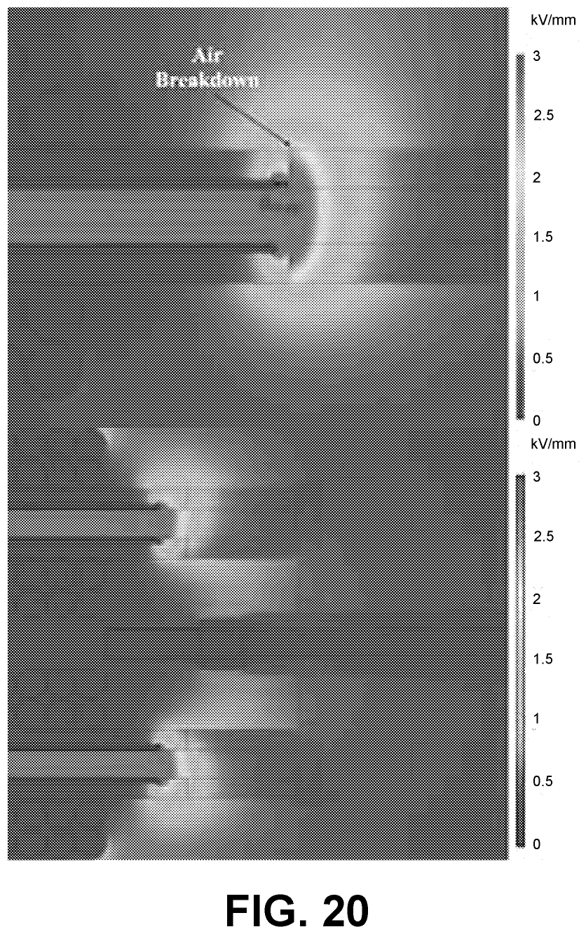

FIG. 20 shows a zoomed-in view of the section where the shield terminates and the electric field dissipates. As illustrated, a complexity arises from the interface of three materials at a single point, needing detailed analysis of field mitigation in such situations. Due to the epoxy's significantly higher permittivity compared to the PP material, the E-field is naturally directed into the PP isolation layer. Therefore, to ensure the E-field remains contained within the PP and does not escape into the air, the epoxy-filled area needs to extend beyond the shield's edge by a certain distance. FIG. 20 depicts E-field management at the edge of the shield for two scenarios. FIG. 20 shows the E-field mitigation at the intersection of the epoxy (εᵣ=5.36), PP (εᵣ=2.25) and air (εᵣ=2.5). In the top view, the epoxy-filled area is insufficient producing unacceptable field mitigation, and in the bottom view the field is correctly mitigated and acceptable.

### Shielding Layer Design Considerations

The shielding layer design involves a trade-off between losses within the shielding layer and its effectiveness in preventing E-field penetration. A highly conductive shield effectively blocks E-field propagation but may lead to significant losses. Conversely, a highly resistive shield will have negligible losses but may not effectively impede E-field propagation.

The proposed transformer design concept includes a continuous shielding layer in all sections where the transformer winding is placed to ensure that the E-field is fully contained within the separation layer, as depicted in FIG. 19. With the placement of the shield defined, the conductivity of shield that will effectively perform the shielding function without incurring significant losses can be identified. A uniform shield of thickness of 0.1 mm was selected and an E field and B field evaluation performed as the conductivity of the shield changed.

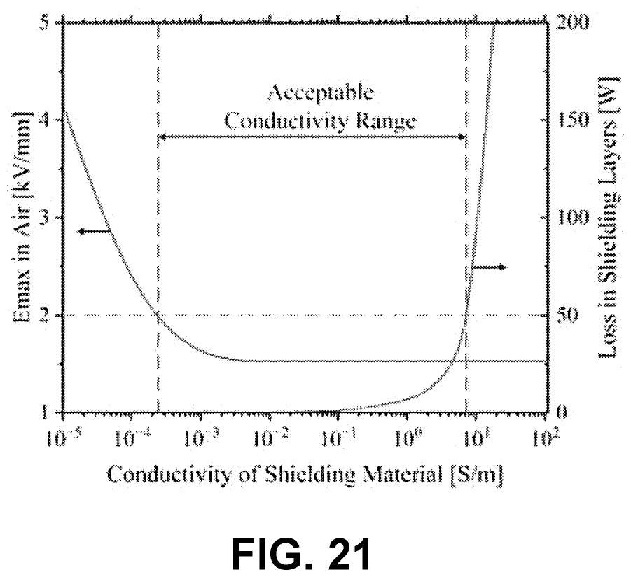

The shielding layer losses primarily arise from two sources: first, the shielding layer forms a single-turn winding where the main flux can induce current; second, eddy currents are induced by the leakage flux. To analyze both effects, a B-field simulation was performed at peak transformer power to determine the shield losses as a function of shield conductivity. An E-field simulation was also conducted with a 15 kV potential difference across the isolation barrier to assess the shield's effectiveness in blocking E-field propagation. In this simulation, coils, cores and the shield on the same side of the isolation barrier were set to the same potential, and a potential difference was applied across the barrier, creating an electric field in the gap. In this configuration, the shield needs to contain the E-field (prevent leakage) while also minimizing losses due to induced currents from the adjacent coil and the magnetic field produced by the main B-field. The blocking effectiveness is quantified by the peak E-field in the air. FIG. 21 presents the results of this analysis and indicates that shield conductivity within the range of about 2.5×10⁻⁴ to about 70 S/m provides an acceptable trade-off between losses in the shield material and shielding effectiveness.

Based on the available semiconductive materials, we have selected a 3D printed shield layer design that uses Protopasta composite conductive PLA CDP11705 as the material from which to build the shield. This material has a surface conductivity that falls withing the range of acceptable conductivities.

From a manufacturability standpoint, incorporating holes in the shielding layer to facilitate epoxy flow through the shield is beneficial. However, introducing holes can potentially reduce the shield's effectiveness. The acceptable size of these holes was investigated based on the conductivity of the selected 3D printing filament. The analysis indicated that a mesh size of 1.5 mm or finer provides good containment of the E-field for the chosen filament.

### Prototype Design

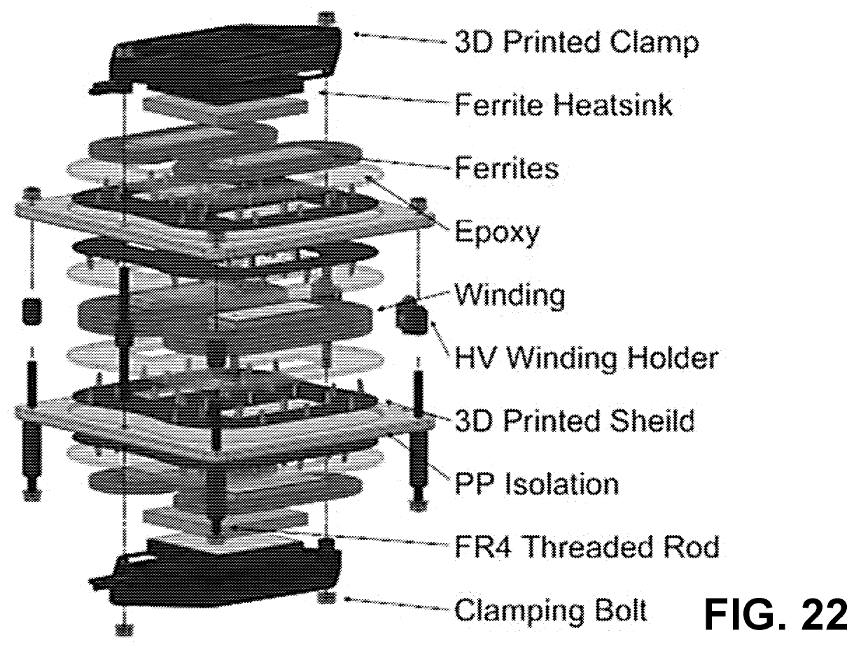

Based on the considerations detailed above, the transformer was designed and constructed as depicted in FIG. 22. As illustrated, the transformer incorporates two isolation barriers fabricated from machined polypropylene (PP). Quarter-inch PP sheets were machined with slots to securely house the shielding layer, leaving a 4 mm layer of PP to serve as the primary electrical isolation. This quarter-inch thickness ensured sufficient potting material above the shielding layer, effectively mitigating electric field leakage through the mesh. The slot dimensions were intentionally larger than the shielding layer to guarantee effective field mitigation at its edges. Beyond the shielding layer, the ferrite core was also positioned within the PP slots. Magnetic field analysis indicated that the top ferrite component experienced the highest loss density within the magnetic circuit. To mitigate this, a heatsink was affixed to the top ferrite using a thermal pad. The transformer assembly is held together with plastic rods and nylon screws.

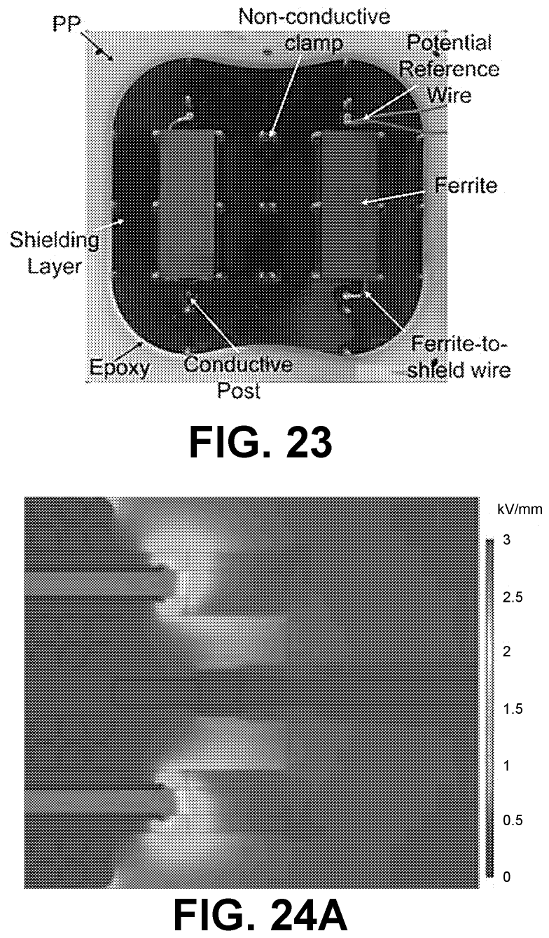

FIG. 23 illustrates the isolation barrier design, featuring a machined PP sheet with the 3D-printed shield and ferrite after epoxy encapsulation. The image details the shield, which has a uniform bottom and incorporates several features on top to aid system assembly and component potential referencing. First, non-conductive clamps are integrated into the shield to secure the winding, preventing it from slipping off the edges. Second, the design includes features to ensure all components on the same side of the shield share a common potential. This is achieved by referencing the transformer winding's negative terminal to both the ferrite and the shield. Metallic inserts, molded into designated features on the shield, provide access to it. The ferrite is also referenced to the shield via a wire connecting a metallic insert to the ferrite, secured with conductive epoxy in a drilled hole.

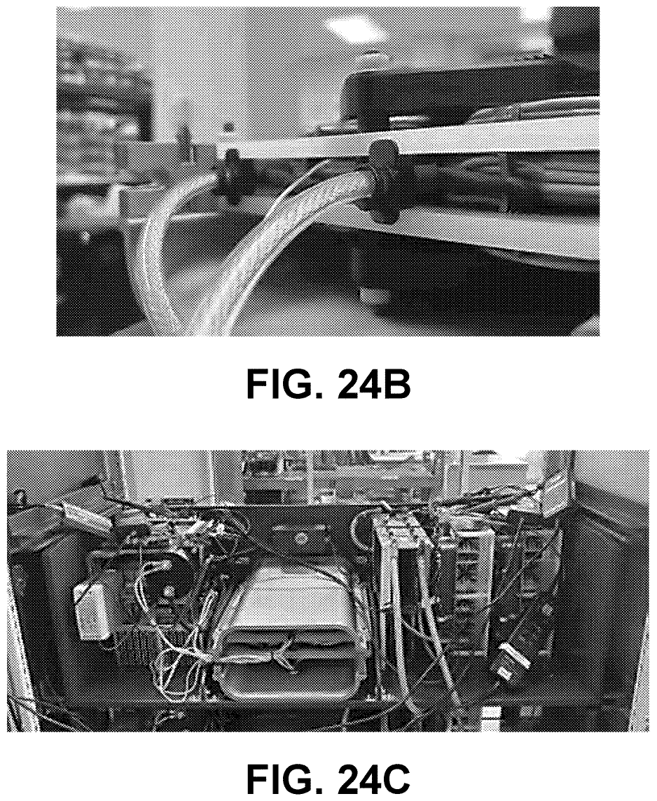

Another important aspect of the design is the HV winding termination. As the HV winding exits the transformer, it will necessarily leave the shielded area and could potentially generate a large electric field (E-field) in the surrounding air if the winding is allowed to be close to the isolation barrier. To mitigate this issue, high-voltage wire holders can be used to maintain a sufficient distance between the wire and the isolation layers. Additionally, high-isolation wire can be employed to minimize the possibility of wire coupling to other grounded components. FIG. 24A illustrates the E-field distribution for the wire exiting through the middle of the HV section, showing no significant E-field around the wire. FIG. 24B is an image of the implemented wire holder for the HV wire termination.

The HV wire needs to be routed to the HV section of the transformer design in a manner that keeps it far away from any grounded components. This is achieved in the design by enclosing the entire power stage in a separate enclosure, where all components referenced to the HV side are on the same side of the transformer. FIG. 24C depicts the entire power stage module, clearly indicating a barrier between the HV and LV sides of the system.

### Experimental Results

A partial discharge (PD) test was performed to confirm the insulation design. PD in power transformers is defined by the International Electrotechnical Commission (IEC) standard 60270 as a localized electrical discharge that only partially bridges the insulation between conductors and which may or may not occur adjacent to a conductor. The Institute of Electrical and Electronics Engineers (IEEE) provides a similar definition, emphasizing that PD is a localized dielectric breakdown of a small portion of the insulation system that does not completely bridge the space between two conducting electrodes. This phenomenon arises when the localized electric field stress within the insulation system surpasses the dielectric withstand capability of that specific area. Monitoring partial discharges in power transformers is a primary indicator of insulation degradation and a precursor to potential failures. A significant majority of transformer faults, estimated to be between 70% and 80%, originate as internal partial discharges within the insulation.

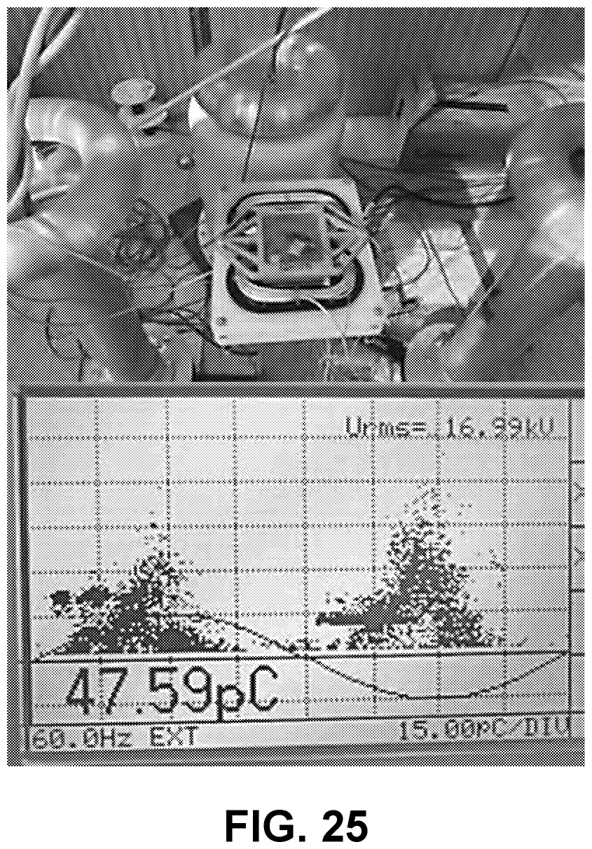

The PD testing was conducted using a Phenix model 4100-10, setting a partial discharge inception/extinction level of 50 pC. The fabricated prototype demonstrated an inception voltage of 17 kV rms and a partial discharge level below 50 pC, meeting the galvanic insulation requirements for this application. The PD test setup and results are shown in FIG. 25.

### Capacitive Current Limiting

As previously discussed, it is a challenge to meet the isolation and partial discharge requirements for a compact high frequency transformer. Efficient cooling is enabled by leaving conductors exposed to air. There is a capacitance between the shield and another between the ferrites. All components on one side of the isolation gap are referenced to the same potential as shown in FIG. 23. The shielding layer is a 3D printed mesh using semiconductive PLA. Reference wires provide access to the shield to shield capacitor and ferrite to ferrite capacitor. This allows to limit the current through the parasitic capacitor by adding an impedance in series.

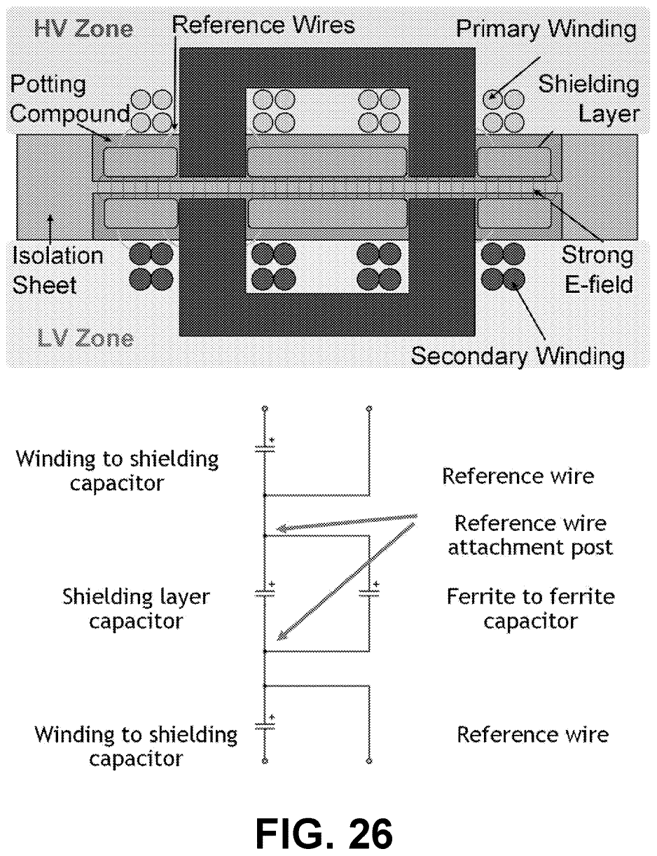

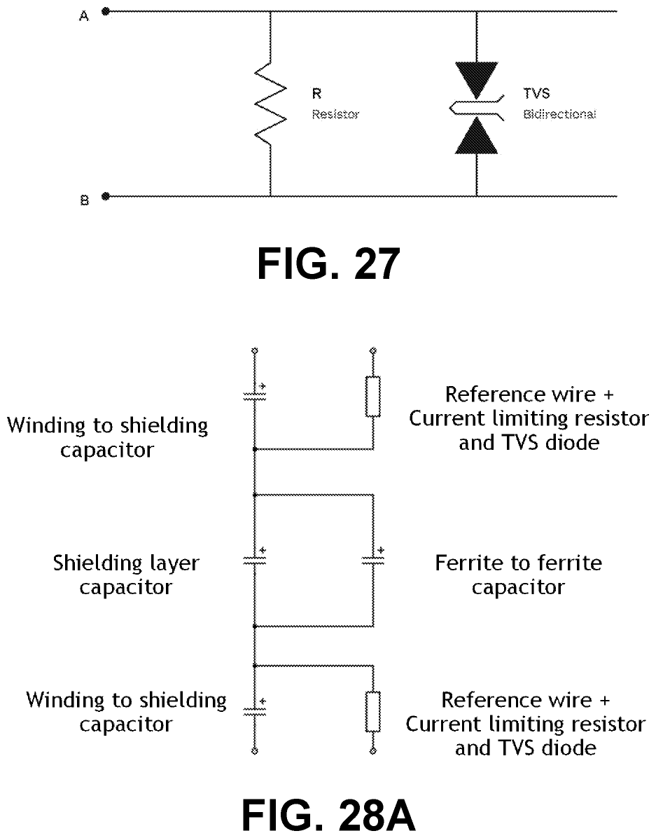

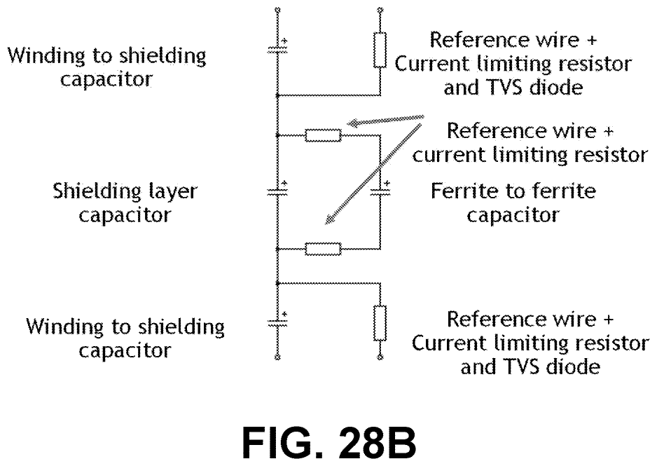

FIG. 26 illustrates the connections of reference wires between the windings, shielding layers, and ferrites for the HV and LV zones. Resistors and/or transient voltage suppression (TVS) diodes as illustrated in FIG. 27 can be added to the connections to limit currents. The resistor limits common-mode current through the transformer capacitance. The TVS diode clamps the voltage across the resistor during high-voltage events (e.g., lightning strikes). Adding the resistor reduces stress on the shield and ferrite cores (the isolation layer components). FIG. 28A illustrates an example of a current limiting resistor and TVS diode connected between the winding and shielding to limit shield-to-shield capacitive current. FIG. 28B illustrates an example of a current limiting resistor connected between the shielding and ferrite core to limited ferrite-to-ferrite capacitive current. Design variations of these arrangements show that the shield layer can be tuned to limit ferrite-to-ferrite capacitive current independently from shield-to-shield capacitive current. In some cases, limiting both is beneficial; in others, it's preferable to allow higher shield current while restricting ferrite current.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A transformer, comprising:
a primary side magnetic core comprising ferromagnetic material;
a secondary side magnetic core comprising the ferromagnetic material;
an isolation sheet disposed between the primary side magnetic core and the secondary side magnetic core, the isolation sheet comprising a plurality of slots configured to receive ends of the primary side magnetic core and the secondary side magnetic core, the isolation sheet comprising shielding located between the primary side magnetic core and the secondary side magnetic core;
a primary winding wound about a section of the primary side magnetic core; and
a secondary winding wound about a section of the secondary side magnetic core, the primary winding and secondary winding separated by the isolation sheet comprising the shielding.

2. The transformer of claim 1, wherein the primary winding is laminated with insulation paper interposed between each layer of turns of the primary winding and the secondary winding is laminated with insulation paper interposed between each layer of turns of the secondary winding.

3. The transformer of claim 1, wherein each slot further comprises a potting compound interposed between the isolation sheet and the primary side magnetic core, the secondary side core, or both.

4. The transformer of claim 1, wherein the shielding comprises a shielding layer disposed within the potting compound.

5. The transformer of claim 4, wherein the shielding layer is positioned in a slot of the isolation sheet with openings to receive the ends of the primary side magnetic core.

6. The transformer of claim 4, wherein the shielding layer comprises semiconductive material with a surface conductivity in a range from about 0.0001 S/m to about 100 S/m.

7. The transformer of claim 1, wherein the shielding comprises conductive or semiconductive particles distributed within the potting compound.

8. The transformer of claim 7, wherein the potting compound comprises epoxy, silicone gel mixed with the conductive or semiconductive particles to make a semiconductive material.

9. The transformer of claim 8, wherein the conductive particles comprise graphite, aluminum, or carbon particles or the semiconductive particles comprise SiC particles.

10. The transformer of claim 1, wherein the potting compound comprises epoxy, silicone gel, or a combination of any thereof.

11. The transformer of claim 1, wherein the isolation sheet has an insulation capability of 20 kV/mm or greater.

12. The transformer of claim 11, wherein the isolation sheet comprises polypropylene.

13. The transformer of claim 1, wherein the primary side magnetic core and secondary side magnetic core are wound ribbon cores.

14. The transformer of claim 1, wherein the primary side magnetic core and secondary side magnetic core are block cores.

15. The transformer of claim 1, wherein the primary side magnetic core and the secondary side magnetic core comprises silicon steel, nanocrystalline, or amorphous core laminations.

16. The transformer of claim 1, wherein the primary side magnetic core and the secondary side magnetic core comprises ferrite.

17. The transformer of claim 1, wherein the secondary side magnetic core comprises a U-shaped core or an E-shaped core.

18. The transformer of claim 17, wherein the primary side magnetic core comprises a U-shaped core or an E-shaped core.

19. The transformer of claim 1, further comprising:
a primary auxiliary winding wound about an exterior of the primary side magnetic core; and
a secondary auxiliary winding wound about an exterior of the secondary side magnetic core, the primary auxiliary winding and secondary auxiliary winding separated by the isolation sheet comprising the shielding.

20. The transformer of claim 1, further comprising:
a second secondary side magnetic core on a side of the primary side magnetic core opposite the secondary side magnetic core;
a second isolation sheet disposed between the primary side magnetic core and the second secondary side magnetic core, the second isolation sheet comprising a plurality of slots configured to receive ends of the primary side magnetic core and the second secondary side magnetic core; and
a second secondary winding wound about a section of the second secondary side magnetic core.

21. The transformer of claim 1, further comprising:
a primary auxiliary winding wound about an exterior of the primary side magnetic core;
a secondary auxiliary winding wound about an exterior of the secondary side magnetic core, the primary auxiliary winding and secondary auxiliary winding separated by the isolation sheet comprising the shielding; and
a second secondary auxiliary winding wound about an exterior of the second secondary side magnetic core, the primary auxiliary winding and second secondary auxiliary winding separated by the second isolation sheet comprising shielding.

22. The transformer of claim 1, comprising a current limiting resistor and a transient voltage suppression diode connected between the primary winding and the shielding.

23. The transformer of claim 1, comprising a current limiting resistor connected between the primary side magnetic core and the shielding.
